(19) United States
(12) Patent Application Publication
(10) Pub. No.: US 2015/0107550 A1
(43) Pub. Date: Apr. 23, 2015

(54) METHOD FOR CONTROLLING AND REGULATING AN INTERNAL COMBUSTION ENGINE ACCORDING TO THE HCCI COMBUSTION METHOD

(71) Applicants: Jörg Remele, Hagnau (DE); Christina Sauer, Friedrichshafen (DE); Aron Toth, Friedrichshafen (DE); Andreas Flohr, Friedrichshafen (DE); Alexander Bernhard, Meckenbeuren (DE); Florian Bach, Schwaigern (DE); Erika Schaefer, Friedrichshafen (DE); Ulrich Spicher, Herxheim (DE); Christoph Teetz, Friedrichshafen (DE)

(72) Inventors: Jörg Remele, Hagnau (DE); Christina Sauer, Friedrichshafen (DE); Aron Toth, Friedrichshafen (DE); Andreas Flohr, Friedrichshafen (DE); Alexander Bernhard, Meckenbeuren (DE); Florian Bach, Schwaigern (DE); Erika Schaefer, Friedrichshafen (DE); Ulrich Spicher, Herxheim (DE); Christoph Teetz, Friedrichshafen (DE)

(73) Assignee: MTU Friedrichshafen GmbH, Friedrichshafen (DE)

(21) Appl. No.: 14/397,041

(22) PCT Filed: Apr. 15, 2013
(86) PCT No.: PCT/EP2013/001110

§ 371 Date: Oct. 24, 2014

(30) Foreign Application Priority Data
Apr. 25, 2012 (DE) 10 2012 008 125.1

(51) Int. Cl. F02D 19/06; F02D 41/30

(52) U.S. Cl. CPC F02D 19/0615; F02D 41/3011
USPC 123/304

(57) ABSTRACT

A method is proposed for controlling and regulating an internal combustion engine according to the HCCI combustion method, in which a first fuel in a basic mixture is ignited using a pilot fuel, and in which the fuel quantities of the first fuel and the pilot fuel are changed to represent an operating point of the internal combustion engine. The invention is characterized in that a target combustion energy (VE(SL)) is calculated as a function of a power demand and, based on the target combustion energy (VE(SL)), the fuel quantity of the first fuel and the fuel quantity of the pilot fuel are determined using a distribution factor (CHI), wherein the distribution factor (CHI) is calculated as a function of an actual combustion position (VL(IST)) to a target combustion position (VL(SL)) using a combustion position controller (18).

### TECHNICAL FIELD

The present disclosure relates to a method for controlling and regulating an internal combustion engine, e.g., according to the Homogeneous Charge Compression Ignition (HCCI) combustion method.

### BACKGROUND

The compliance with future exhaust gas emission limit values at simultaneously low fuel consumption and low CO₂ emissions is an essential demand in the development of off-highway engines. In particular, diesel engines in the power range from 130 kW to 560 kW, for which the EPA Tier 4 legislation will be applicable in the USA starting in 2014, come in under the required limit values only by using a combination of internal engine measures and exhaust gas post-treatment systems (e.g., Selective Catalytic Reduction (SCR), particle filters). Due to this, the complexity and costs of the diesel engine increase significantly. With regard to the CO₂ emissions and, in terms of the constantly increasing diesel demands, alternative fuels are also coming more strongly into the fore.

The homogeneous charge compression ignition, the HCCI combustion method, represents an alternative to expensive exhaust gas post-treatment systems. During the HCCI combustion method, almost no soot or nitric oxide emissions are produced. However, new challenges result with this combustion method with regard to the combustion control and engine load. Due to the fast heat release, which occurs during all HCCI combustion methods, high-pressure gradients occur, such that the method was limited up until now to the partial load operational range. In the HCCI combustion method, a diluted, homogeneous fuel-air mixture is ignited by the compression. The time of the autoignition is a function of the blend composition and the thermodynamic state of charge, and is thus can no longer be directly controlled. The autoignition starts simultaneously at several locations in the combustion chamber. This results in short combustion periods, which positively influence the degree of efficiency. Since, due to the homogeneous mixture, no locally rich or hot zones occur, particles and nitric oxide are avoided. In comparison with a conventional gasoline engine, HCCI enables a significant reduction in fuel consumption in the partial load operational range while maintaining the economical three-way catalytic converter. In combination with a diesel engine, HCCI offers the possibility of foregoing expensive exhaust gas post-treatment systems without losses in inefficiency.

The essential challenges in the realization of this combustion method are the controllability and the possible characteristic map range. Due to the high sensitivity of the method to changes in the thermodynamic limit conditions, a combustion regulation is necessary that counters external influences. Because of the different characteristics of gasoline and diesel, different limit conditions and demands arise with respect to the implementation of this combustion method in the respective engine. The fuels differ in their evaporation characteristics and in their combustibility. Gasoline already evaporates at low temperatures, such that homogeneous mixtures are easy to constitute. The mixture formation is possible using conventional intake manifold injections as will as using gasoline direct injection. However, due to the low combustibility of gasoline, higher temperatures are necessary during the compression in order to ensure combustion. These can be realized e.g. by high internal residual gas rates. In contrast to gasoline, diesel has a high combustibility; however the evaporation characteristics are substantially worse. Therefore, an external mixture formation cannot be constituted using conventional injection valves. Even direct injection can only occur in a narrow range toward the end of the compression, since otherwise wall depositions and oil thinning occur. In order to obtain a largely homogeneous mixture in spite of this, an increase in the ignition delay through high exhaust gas recirculation rates is necessary. Gasoline and also diesel engine HCCI is limited to the partial load operational range, since the typically fast heat release leads to pressure gradients that are too high, and which at increasing loads exceed the allowable load limit of the respective engine. For passenger car engines, whose emission test cycles are limited to the partial load operational range, HCCI offers, in spite of the limited usage range, the possibility of maintaining future emission limit values without expensive exhaust gas post-treatment, and while using the consumption advantages in the gasoline engine. For industrial engines, whose emission test cycles include full load due to their load spectrum, the characteristic map range must, however, be significantly expanded. In light of the contrasting characteristics of gasoline and diesel, it is obvious to use the advantages of both fuels and in this way constitute higher loads and also control the autoignition. Thus, in a dual-fuel HCCI combustion method, the autoignition of a diluted homogeneous gasoline air mixture is introduced by the injection of small quantities of diesel. The homogeneous base mixture can be generated through intake manifold injection of through direct injection during the intake stroke. The diesel injection occurs over the course of the compression stroke, wherein the injection is started in such a way that the diesel is also largely homogeneously combusted. Subsequently in the text, diesel is also designated as a pilot fuel and gasoline is also designated as the first fuel.

A control method for an internal combustion engine according to the HCCI combustion method using two fuels is known, e.g., from DE 10 2004 062 019 A1. The method is supposed to be able to be applied in all operational ranges, in that at full load, a lean, homogeneous gasoline mixture is selected with stratified diesel fuel, and a contrasting strategy is selected for partial loads. The two fuels are respectively injected via separate common-rail systems, either mutually in the compression stroke or the first fuel in the intake stroke and the pilot fuel in the compression stroke. The injection start and the injection duration of the two fuels is determined using the operating point and/or the pressure curve measured in the combustion chamber. Further measures for determining the combustion curve are, however, not demonstrated in the reference.

Another control method for an internal combustion engine according to the HCCI combustion method using two fuels is known from WO 2010/149362 A1. The internal combustion engine is supplementally provided with a two-stage turbocharger and exhaust gas recirculation. The method consists in that the pilot fuel fraction and the EGR quantity are varied. Thus, during full load, a five percent diesel fraction of the total fuel quantity and zero percent EGR rates are set. During idle, a fifteen percent diesel fraction and fifty to seventy percent EGR rates are set. More detailed information for implementing the method are, however, not depicted in the reference.

### SUMMARY

It is therefore the underlying object of the present disclosure to specify the HCCI combustion method for an internal combustion engine using two fuels with external exhaust gas recirculation.

One method, according to an exemplary illustration, includes calculating a target combustion energy as a function of a performance requirement and the target combustion energy is constituted via the distribution of the two fuels, in particular diesel as the pilot fuel and gasoline as the first fuel. The distribution is in turn determined by a combustion position controller, which calculates a distribution factor as a control variable based on the actual to target combustion position. For example, the combustion position controller corrects an actual combustion position that is too late through an increase of the pilot fuel fraction. One exemplary approach is to use the diesel and/or gasoline fraction as control variables for the combustion position controller, since in this case a constant relationship exists between the control variables and the combustion variables. The control at the 50% conversion point, also called the MFB50, emphasizes the simplicity of the method. The technical feasibility of the dual-fuel HCCI method is only provided by this means. The optimization of the control variable occurs with respect to the efficiency while maintaining the allowable mechanical load. It is advantageous that the emissions are likewise optimized in this way, since increased NOₓ emissions occur during very early, and thus not efficiently optimized, combustion.

For more precise adjustment, in another exemplary illustration a combustion position controller is respectively provided per cylinder of the internal combustion engine, such that an individual cylinder distribution factor can be calculated. Supplementally, an individual cylinder correction is provided of the fuel quantity of the pilot fuel or the flow duration for the injector, via which the pilot fuel is injected. The correction of the fuel quantity or the flow duration effects a cylinder equalization, by which means an increased smooth running is achieved. A high process reliability with regard to stochastic errors during signal detection is achieved, in that the actual combustion position is determined as a function of the measured cylinder pressure using a minimum value selection.

### BRIEF DESCRIPTION OF THE DRAWINGS

Referring now to the drawings, illustrative examples are shown in detail. Although the drawings represent the exemplary illustrations described herein, the drawings are not necessarily to scale and certain features may be exaggerated to better illustrate and explain an innovative aspect of an exemplary illustration. Further, the exemplary illustrations described herein are not intended to be exhaustive or otherwise limiting or restricting to the precise form and configuration shown in the drawings and disclosed in the following detailed description. Exemplary illustrations of the present invention are described in detail by referring to the drawings as follows:

FIG. 1 A system diagram, according to an exemplary illustration;

FIG. 2 A block diagram, according to an exemplary illustration;

FIG. 3 A block diagram for determining the flow duration, according to an exemplary illustration;

FIG. 4 A block diagram for determining the actual combustion position, according to an exemplary illustration;

FIG. 5 An engine characteristic map, according to an exemplary illustration;

FIG. 6 A phase diagram of the combustion curve, according to an exemplary illustration;

FIG. 7 A characteristic curve, according to an exemplary illustration; and

FIG. 8 Multiple combustion curves according to an exemplary illustration.

### DETAILED DESCRIPTION

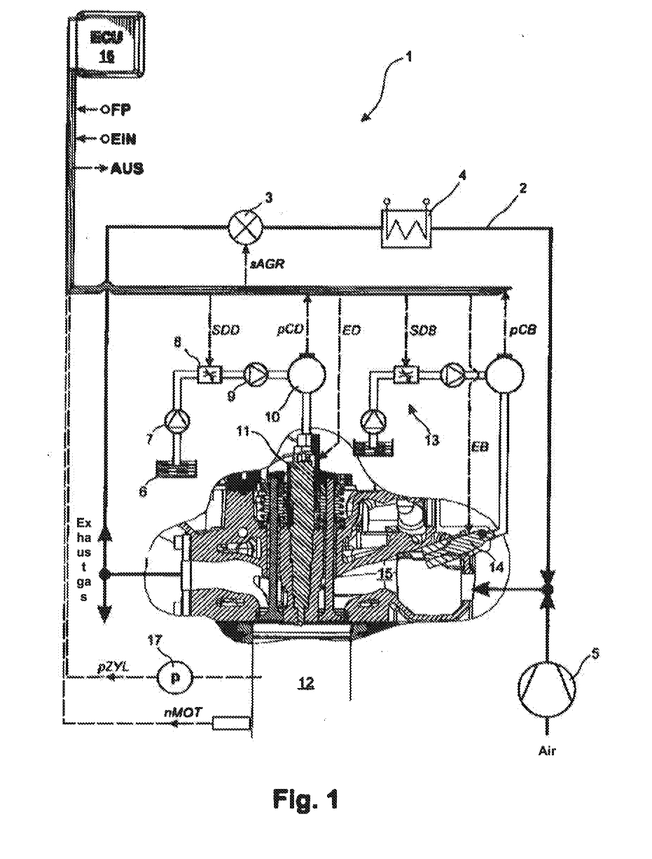

FIG. 1 shows a system diagram of an exemplary electronically controlled internal combustion engine 1, which may be operated according to the dual-fuel HCCI combustion method. The additional description relates exemplarily to gasoline as a first fuel and diesel as a pilot fuel. The internal combustion engine has exhaust gas recirculation and a turbocharger. An EGR valve 3 for determining the recirculated exhaust gas quantity and a heat exchanger 4 are arranged in the external exhaust gas recirculation 2. A compressor is schematically indicated by reference 5, which compressor is part of a two-stage turbocharger. The injection system of the internal combustion engine consists of a common rail system for injecting the first fuel and a separate common rail system for injecting the pilot fuel. The common rail system for injecting the pilot fuel comprises the following mechanical components: a low-pressure pump 7 for conveying the pilot fuel out of a tank 6, a variable suction throttle 8 for influencing the through flowing volume flow, a high-pressure pump 9 for conveying the pilot fuel under increased pressure, a rail 10 for storing the pilot fuel, and an injector 11 for injecting the pilot fuel into the combustion chamber 12. The common rail system 13 for the first fuel is designed to be structurally similar, wherein in this case, however, gasoline is injected into an inlet manifold 15 via an injection valve 14. Instead of the intake manifold injection, the first fuel could also be injected directly into the combustion chamber 12 via an independent injector. The common rail system can also be optionally equipped with individual storage spaces, wherein, for example, an individual storage is integrated in the injector 11 as additional buffer volume.

The operational mode of the internal combustion engine 1 is determined by an electronic engine control unit (ECU) 16. In one exemplary illustration, the engine control unit 16 includes the conventional components of a microcomputer system, for example, a microprocessor, I/O components, buffer and memory components (EEPROM, RAM). Operating data relevant to the operation of the internal combustion engine 1 are applied in characteristic maps/curves in the memory components. The engine control unit 16 calculates the output variables from the input variables using said characteristic maps/curves. FIG. 1 exemplarily depicts the following input variables: the rail pressure pCD of the pilot fuel, the rail pressure pCB of the first fuel, a cylinder pressure pZYL (sensor 17), an engine speed nMOT, a signal FP in reference to power demanded by the operator, and an input variable EIN. The input variable EIN consolidates further sensor signals, for example the charge air pressure and the temperature upstream of the inlet valves of the internal combustion engine. FIG. 1 depicts as the output variables of the engine control unit 16: a signal SDD for controlling the suction throttle 8 for the pilot fuel, a signal ED for controlling the injector 11 (injection start/injection end), a signal SDB for controlling the quantity control valve for the first fuel, a signal EB for controlling the injection valve 14 (injection start/injection end), a control signal sAGR for controlling the EGR valve 3, and an output variable AUS. The output variable AUS represents the further control signals for controlling and regulating the internal combustion engine 1, for example a control signal for activating a second exhaust gas turbocharger in a multistage turbocharger.

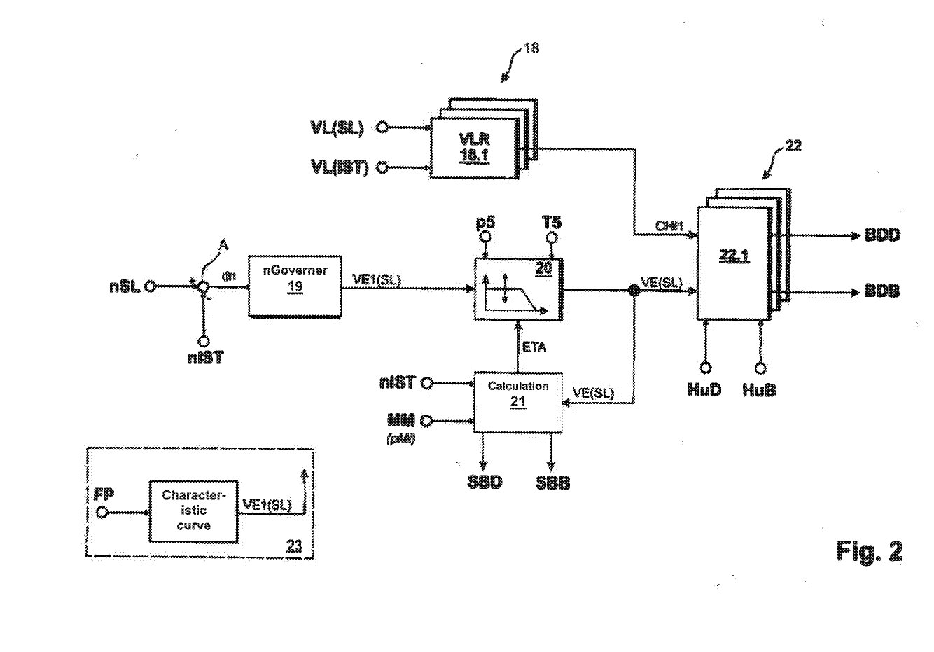

FIG. 2 shows a block diagram, which represents the program parts or program steps of an executable program. The injection quantities of the two fuels are calculated using the block diagram of FIG. 2. The input variables of the block diagram, in this exemplary approach, are the target speed nSL, the actual speed nIST, the engine torque MM, alternatively the indicated mean pressure pMI, a target combustion position VL(SL), the actual combustion position VL(IST), the lower caloric value HuD of the pilot fuel, and the lower caloric value HuB of the first fuel, that is the gasoline. The output variables are: a first flow duration BDB, a first injection start SBB, a second flow duration BDD, and a second injection start SBD. The first flow duration BDB and the first injection start SBB characterize the gasoline injection, since the injection valve is impinged using these control signals.

The second flow duration BDD and the second injection start SBD characterize the diesel injection, since the injector is actuated using these control signals.

A combustion position controller 18 determines a distribution factor CHI as a control variable based on the actual combustion position VL(IST) and the target combustion position VL(SL). In one exemplary illustration, one combustion position controller is assigned to all cylinders of the internal combustion engine. In another exemplary approach that is depicted, each cylinder of the internal combustion engine is assigned its own combustion position controller. Thus, for example, the combustion position controller 18.1 determines the distribution factor CHI1 for the first cylinder. The pilot fuel fraction and the fraction of the first fuel to the total fuel energy are determined using the distribution factor CHI. A distribution factor of, for example, CHI=0.93 means that 93% gasoline and 7% diesel are injected. The distribution factor CHI is the first input variable of a calculation 22. In one example, one calculation 22 is assigned to all cylinders of the internal combustion engine. In the example depicted, each cylinder of the internal combustion engine is assigned its own calculation 22, for example, the calculation 22.1 is assigned to the first cylinder. The second input variable of the calculation 22 is the target combustion energy VE(SL). The target combustion energy VE(SL) is calculated as a function of the desired output. In a speed or torque-based system, this is the target speed nSL. In the simpler case, this can also be an accelerator pedal position FP, as this is depicted in FIG. 2 as an alternative using reference 23. At a summation point A, the actual speed nIST is compared with the target speed nSL, from which the speed control deviation dn results. A governor 19 determines in turn from the speed control deviation dn a first target combustion energy VE1(SL) as a control variable, unit: joules. Typically, the governor 19 includes a PIDT1 behavior. The first target combustion energy VE1(SL) is limited via a first limit 20. The output variable corresponds to the target combustion energy VE(SL), which is the second input variable of the calculation 22. A speed limit and a charge pressure limit are consolidated in the limit 20. The input variables of the limit 20 are therefore the pressure p5 upstream of the inlet values, thus the charge pressure, and the temperature T5 upstream of the inlet valves of the internal combustion engine. Included in the consideration of the limit 20 is an efficiency ETA, which is determined using a calculation 21. Using the calculation 21, the first injection start SBB for controlling the injection valve and the second injection start SBB for controlling the injector is calculated as a function of the actual speed nIST, the target combustion energy VE(SL), and the delivered engine torque MM or the indicated mean pressure pMI of the efficiency ETA. Using the distribution factor CHI and the target combustion energy VE(SL), the calculation 22 then determines per individual cylinder the first flow duration BDB for the injection valve and the second flow duration BDD for the injector.

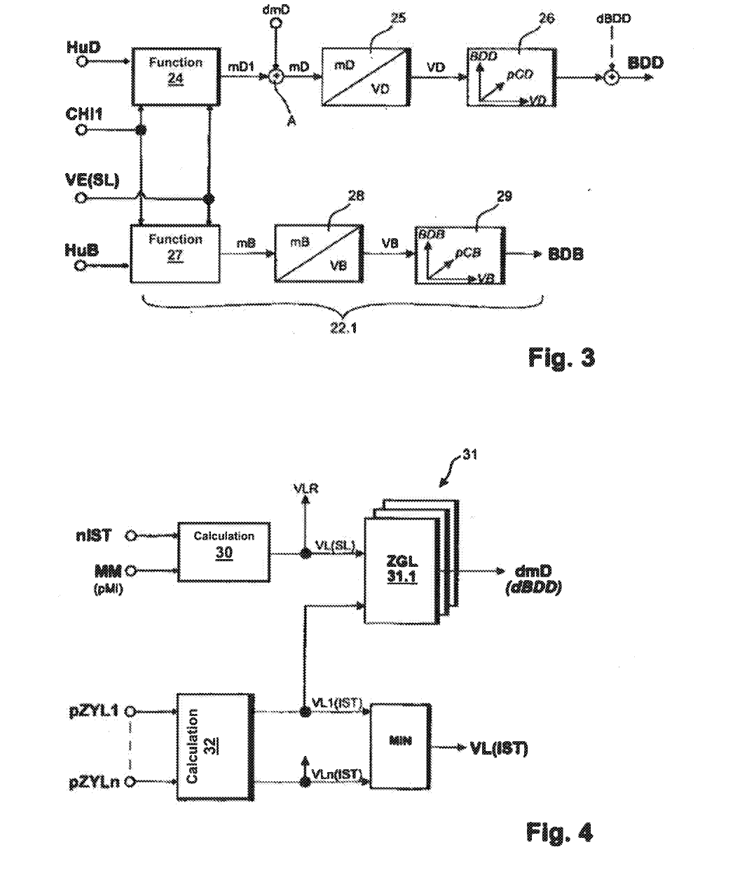

FIG. 3 shows in detail the calculation 22 from FIG. 2, by way of example the calculation 22.1 for the first cylinder, according to an exemplary illustration. The input variables are the caloric value HuD of the pilot fuel, the caloric value HuB of the first fuel, the target combustion energy VE(SL), and the distribution factor CHI, here, for example, the distribution factor CHI1 for the first cylinder. The output variables are the first flow duration BDB and the second flow duration BDD. In a function block 24, the difference of the unitless distribution factor CHI1 to one is shown in a first step. In a second step, this difference is then multiplied by the target combustion energy VE(SL), and, in a third step, divided by the caloric value HuD of the pilot fuel, unit: joules/mg. The output variable of function block 24 corresponds to the first fuel quantity mD1 of the pilot fuel using milligrams as units. At a summation point A, a correction fuel quantity dmD is added to the first fuel quantity mD1. The correction fuel quantity dmD serves the cylinder equalization. The calculation of the correction fuel quantity dmD is described in connection with FIG. 4. The sum of the first fuel quantity mD1 and the correction fuel quantity dmD corresponds to the fuel quantity mD, which is converted into a volume flow VD using a calculation 25. The second flow duration BDD is then calculated as a function of the volume flow VD and the rail pressure pCD of the pilot fuel using a characteristic map 26, by means of which second flow duration the injector for injecting the pilot fuel is controlled. The cylinder equalization can also be achieved in that the flow duration is adjusted as an output variable from the characteristic map 26 using a flow correction dBDD. This alternative is indicated in FIG. 3 by dashed lines. In a first step in a function block 27, the unitless distribution factor CHI1 is multiplied by the target combustion energy VE(SL), and divided by the caloric value HuB of the first fuel (gasoline), unit: joules/mg. The output variable of the function block 27 corresponds to the fuel quantity mB using milligrams as units. Afterwards, the fuel quantity mB is converted into a volume flow VB using a calculation 28. The first flow duration BDB is calculated as a function of the volume flow VB and the rail pressure pCB of the first fuel using a characteristic map 29, by means of which first flow duration the injection valve for injecting the first fuel is controlled.

FIG. 4 depicts a block diagram for calculating the correction fuel quantity dmD, alternatively the flow correction dBDD, and the actual combustion position VL(IST), according to an exemplary illustration. The input variables of the block diagram are the actual speed nIST, the engine torque MM, or the indicated mean pressure pMI, and the measured cylinder pressures pZYL1 to pZYLn. With respect to an internal combustion engine with six cylinders, these would be the cylinder pressures pZYL1, pZYL2, to pZYL6. Based on the actual speed nIST and the engine torque MM, alternatively the indicated mean pressure pMI, the target combustion position VL(SL) is calculated using a calculation 30, which target combustion position is the first input value for a cylinder equalization 31 (ZGL). A cylinder equalization 31 is assigned to each cylinder. Thus, for example, the cylinder equalization 31.1 is assigned to the first cylinder. The target combustion position VL(SL) is simultaneously the input variable for the combustion position controller VLR, see FIG. 2. Using a calculation 32, the net heat release is calculated from the measured cylinder pressure pZYL1 of the first cylinder by means of integration. The position of the net heat release is characterized in relation to the crankshaft angle above the 50% conversion point (MFB50). This 50% conversion point therefore corresponds, for the first cylinder, to the first actual combustion position VL1(IST). The 50% conversion point for the n^{th} cylinder then corresponds to the n^{th} actual combustion position VLn(IST). The first actual combustion position VL1(IST) is simultaneously the second input value for the cylinder equalization ZGL, in this case the cylinder equalization 31.1. Based on the deviation of the target combustion position VL(SL) from the first actual combustion position VL1(IST), the cylinder equalization 31.1 then determines for the first cylinder, for example using PI behavior, the correction fuel quantity dmD of the pilot fuel for the first cylinder. This occurs in a corresponding way for the n^{th} cylinder. From the calculated actual combustion positions VL1(IST) to VLn(IST), the minimum value is then determined, using a selection of minimum value MIN, and set as the actual combustion position VL(IST). The selection of minimum value improves the process reliability with regard to stochastic errors during signal detection. The actual combustion position is subsequently further processed in the combustion position controller VLR.

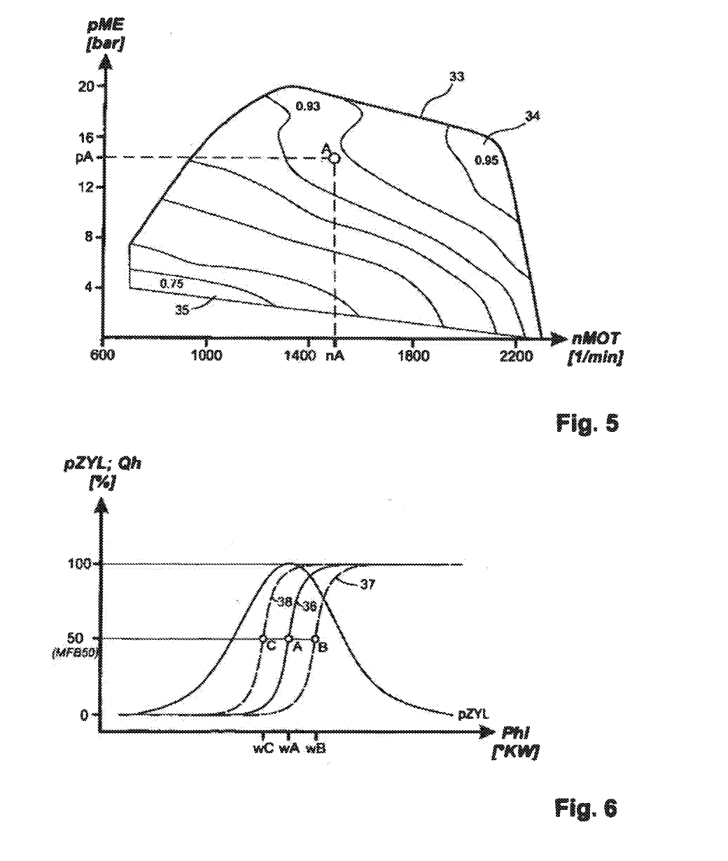

FIG. 5 shows an engine characteristic map, according to an exemplary illustration. The engine speed nMOT is entered on the X-axis, the Y-axis shows the mean pressure pME in bar, which also characterizes the engine torque. The engine characteristic map is limited by a full load line 33. The ranges of the constant fraction of the first fuel—that is the gasoline—to the total fuel energy are depicted within the engine characteristic map. Thus, by way of example, in a first range 34 of higher power demands, a gasoline fraction of 0.95 is set. Correspondingly, in a second range 35 at lower power outputs, a gasoline fraction of 0.75 is set. It is generally applicable that the gasoline fraction is determined for an operating point using the characteristic map. Thus, by way of example, the operating point A is characterized by the engine speed nMOT=nA and by the mean pressure pME=pA. Corresponding to the position of the operating point A in the engine characteristic map, there results in this case a gasoline fraction of 0.93. This corresponds to a gasoline proportion of 93% and a diesel proportion of 7% of the total fuel energy. It is clear from FIG. 5 that, in the majority of the characteristic map, the homogeneous basic mixture can be ignited using very small quantities of pilot fuel (gasoline fraction>0.9). Only at low loads does the pilot fuel fraction increase, since very low charge temperatures are present in this case. At increasing loads, increasingly earlier diesel injection points and higher gasoline fractions are necessary in order to extend the injection delay time, since the increasing temperature favors autoignition. The start of controlling the diesel injector moves within the entire engine characteristic map between 30° of the crank angle and 60° of the crank angle before top dead center (ZOT). In this injection range, it is ensured that a two-stage heat release with increased nitric oxide emissions is avoided.

FIG. 6 shows the normalized cylinder pressure pZYL in percent over the crankshaft angle Phi in degrees, and the normalized net heat release Qh calculated therefrom, likewise shown in percent, according to an exemplary illustration. Reference 36 shows an ideal net heat release as a solid line. The point, at which 50% of the fuel quantity is converted, is defined as the 50% conversion point. At the ideal net heat release 36, operating point A of crankshaft angle Phi=wA corresponds with the 50% conversion point MFB50. In the present example, the operating point A therefore characterizes the target combustion position VL(SL). In contrast, reference 37 shows a net heat release deviating from the ideal. In contrast to the ideal net heat release 36, the 50% conversion point in this case lies above the operating point B at a crankshaft angle Phi=wB which is too late. In this case, the combustion position controller (FIG. 2: 18) calculates a decreasing distribution factor CHI based on the target-actual deviation of the combustion position, that means, the fraction of pilot fuel is increased. Reference 38 likewise shows a net heat release deviating from the ideal. In contrast to the ideal net heat release 36, in this case the 50% conversion point lies above the operating point C at a crankshaft angle Phi=wC which is too early. In this case, the combustion position controller (FIG. 2: 18) calculates an increasing distribution factor CHI based on the target-actual deviation of the combustion position, that means, the fraction of pilot fuel is decreased.

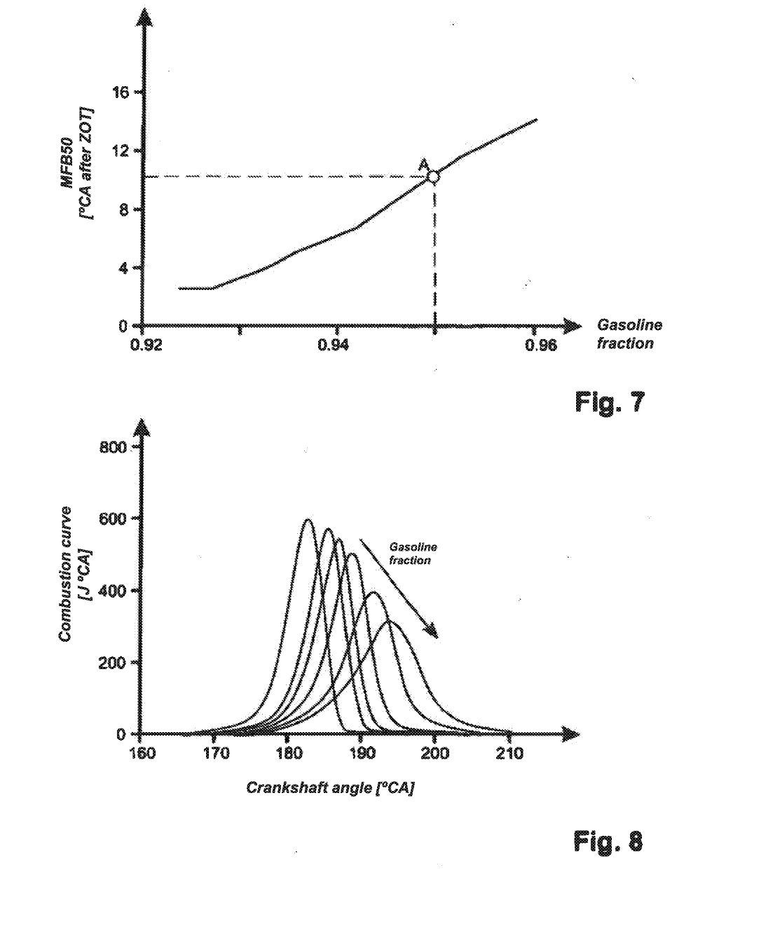

FIG. 7 and FIG. 8 again depict the influence of the first fuel, in this case gasoline, on the combustion, according to one exemplary approach. In this case, FIG. 7 shows the influence on the 50% conversion point in degrees of the crankshaft angle downstream from the upper top dead center ZOT. As is clear from FIG. 7, there is a practically linear dependency of the 50% conversion point, that is the actual combustion point, on the gasoline fraction. FIG. 8 likewise shows the influence of the gasoline fraction on the gross heat release. It is clear from both figures that the combustibility of the cylinder charge decreases and the ignition delay time increases when the gasoline fraction is increased.

The exemplary illustrations are not limited to the previously described examples. Rather, a plurality of variants and modifications are possible, which also make use of the ideas of the exemplary illustrations and therefore fall within the protective scope. Accordingly, it is to be understood that the above description is intended to be illustrative and not restrictive.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain examples, and should in no way be construed so as to limit the claimed invention.

Accordingly, it is to be understood that the above description is intended to be illustrative and not restrictive. Many examples and applications other than the examples provided would be upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future examples. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “the,” etc. should be read to recite one or more of the indicated elements unless a claim recites an explicit limitation to the contrary.

1. Method for controlling and regulating an internal combustion engine configured to operate according to a Homogeneous Compression Charge Ignition (HCCI) combustion cycle, in which a first fuel in a basic mixture is ignited using a pilot fuel, and in which respective initial quantities of the first fuel and the pilot fuel are changed to represent an operating point of the internal combustion engine, comprising:
determining a target combustion energy as a function of a power demand,
determining a subsequent first fuel quantity of the first fuel and a subsequent pilot fuel quantity of the pilot fuel based at least upon the target combustion energy, using a distribution factor, wherein the distribution factor is calculated as a function of an actual combustion position in relation to a target combustion position using a combustion position controller; and
changing the operating point of the internal combustion engine from the respective initial quantities of the first fuel and the pilot fuel to the respective subsequent quantities of the first fuel and the pilot fuel.

2.-7. (canceled)

8. Method according to claim 1, further comprising determining an individual cylinder distribution factor for each cylinder of the internal combustion engine.

9. Method according to claim 8, wherein a combustion position controller is assigned to each cylinder of the internal combustion engine, the individual cylinder distribution factor for each cylinder of the engine being determined by the respective assigned combustion position controller.

10. Method according to claim 1, further comprising determining the actual combustion position based at least in part upon the cylinder pressure.

11. Method according to claim 1, further comprising determining the actual combustion position using a selection of minimal value from a plurality of cylinder pressures.

12. Method according to claim 1, further comprising determining a first flow duration for controlling an injection valve based upon at least the fuel quantity of the first fuel; and
determining a second flow duration for controlling an injector based at least upon the fuel quantity of the pilot fuel.

13. Method according to claim 12, further comprising determining, for each cylinder of the internal combustion engine, a correction of the flow duration for adjusting the pilot fuel for the purpose of a cylinder equalization as a function of cylinder pressure.

14. Method according to claim 12, further comprising determining, for each cylinder of the internal combustion engine, a correction of the fuel quantity for adjusting the pilot fuel for the purpose of a cylinder equalization as a function of cylinder pressure.

15. Method according to claim 1, wherein the changing of the operating point of the internal combustion engine includes changing the operating point of the internal combustion engine via the combustion position controller.

16. A method, comprising:
providing an internal combustion engine configured to operate according to a Homogeneous Compression Charge Ignition (HCCI) combustion cycle, in which a first fuel in a basic mixture is ignited using a pilot fuel, and in which respective initial quantities of the first fuel and the pilot fuel are changed to represent an operating point of the internal combustion engine;
determining a target combustion energy as a function of a power demand;
determining a subsequent first fuel quantity of the first fuel and a subsequent pilot fuel quantity of the pilot fuel based at least upon the target combustion energy, using a distribution factor, wherein the distribution factor is calculated as a function of an actual combustion position in relation to a target combustion position using a combustion position controller; and
changing the operating point of the internal combustion engine from the respective initial quantities of the first fuel and the pilot fuel to the respective subsequent quantities of the first fuel and the pilot fuel.
